(19) United States
(12) Patent Application Publication
(10) Pub. No.: US 2013/0319275 A1
(43) Pub. Date: Dec. 5, 2013

(54) METHOD FOR PROVIDING A PRINTED PATTERN

(71) Applicants: Elsie A. Fohrenkamm, St. Paul, MN (US); David E. Brown, St. Paul, MN (US); Charles W. Simpson, Lakeland, MN (US); M. Zaki Ali, Mendota Heights, MN (US)

(72) Inventors: Elsie A. Fohrenkamm, St. Paul, MN (US); David E. Brown, St. Paul, MN (US); Charles W. Simpson, Lakeland, MN (US); M. Zaki Ali, Mendota Heights, MN (US)

(21) Appl. No.: 13/483,227

(22) Filed: May 30, 2012

(51) Int. Cl. B41F 3/28

(52) U.S. Cl. 101/483

(57) ABSTRACT

A method for providing a pattern, such as printed lines, is carried out by applying ink to a surface of a substrate. The ink and substrate are chosen such that the such that the polarity (γ^{P}/γ^{D})^{1/2} of the substrate surface is less than or equal to 0.6 and the difference in polarity of the substrate surface and the ink [Δ(Polarity)] is less than or equal to 0.1. The result is higher resolution in the printed pattern such as higher resolution in printed lines.

### FIELD OF THE INVENTION

This invention relates to a method for providing printed patterns including printed lines. The invention also provides a method for applying ink to specific substrates to provide printed patterns with improved resolution.

### BACKGROUND OF THE INVENTION

Printed patterns can be used in various industries to provide patterns of conductive or non-conductive lines, shapes, or areas. In addition, relief images can be provided and used in various articles for many different purposes. For example, the electronics, display, and energy industries rely on the formation of coatings and patterns of conductive materials to form circuits on various organic and inorganic substrates. Such coatings and patterns are often provided using relief imaging methods and relief image forming elements. There is also a need for means to provide fine wiring in various articles.

Methods for forming fine wire patterns have been applied using etching resist methods and laser methods. In addition, ink jet patterns have been applied to substrates that are treated with fluorine containing liquids as described in U.S. Pat. No. 7,776,407 (Jung et al.).

Flexography is a method of printing that is commonly used for high-volume printing runs. It is usually employed for printing on a variety of soft or easily deformed materials including but not limited to, paper, paperboard stock, corrugated board, polymeric films, fabrics, metal foils, glass, glass-coated materials, flexible glass materials, and laminates or multiple materials. Coarse surfaces and stretchable polymeric films are economically printed using flexography. Flexographic printing members are sometimes known as “relief” printing members (for example, relief-containing printing plates, printing sleeves, or printing cylinders) and are provided with raised relief images onto which ink is applied for application to a printable material. While the raised relief images are inked, the relief “floor” should remain free of ink. The flexographic printing precursors are generally supplied with one or more imageable layers that can be disposed over a backing layer or substrate. Flexographic printing also can be used to provide patterns of fine lines.

Touch sensitive panels and other display devices require very fine line patterns to achieve high visual transparency. In general, flexographic or letterpress printing processes cannot be used to print very fine continuous lines because of the problem of “line width growth” as the printed line is undesirably wider than the line on the printing plate used to apply an impression. For example, a printing plate having a line width of about 10 μm can result in a printed line impression having a width of 15-20 μm even after all printing press conditions are optimized. This “line width growth” is similar to the problem of “dot gain” that can be experienced in flexographic or letterpress printing.

U.S. Pat. No. 8,025,918 (Broguiere et al.) describes high definition printing with waterborne inks onto non-porous substrates that are coated with a silyl-containing copolymer. U.S. Patent Application Publication 2006/0159838 (Kowalski et al.) describes processes for controlling ink migration during printing of electrical features or patterns.

There is a need to improve the ability to print fine lines without significant “line width growth” or “dot growth” from the printing member to the printed impression. There is also a need to improve fine line resolution in the printed impressions. These problems need to be solved irrespective of the type of substrate to which the fine line pattern is to be applied.

### SUMMARY OF THE INVENTION

The present invention provides a method for providing a printed pattern, the method comprising:

applying ink to a surface of a substrate to form a pattern on the substrate surface,

wherein the ink and substrate are chosen such that the polarity (γ^{P}/γ^{D})^{1/2} of the substrate surface is less than or equal to 0.6 and the difference in polarity of the substrate surface and the ink [Δ(Polarity)] is less than or equal to 0.1.

For example, the ink can be applied to the surface of the substrate using a contact printing member, such as a relief printing member.

The method of the present invention provides a way to improve the resolution in lines or patterns that are applied using relief printing techniques, such as flexography and letterpress printing. The present invention is achieved by choosing an ink and the substrate onto which the ink pattern is to be printed such that the difference in polarity between the substrate surface and the polarity of the ink is less than or equal to 0.1 and the substrate surface polarity is less than or equal to 0.6.

It has been found that such conditions provide printed patterns where the line resolution is increased. For example, “line width growth” or “line gain” is reduced with the present invention.

The present invention can be used to provide printed patterns on a variety of substrates for many different devices including but not limited to, touch sensitive panels and other display devices for example to provide printed conductive patterns using from conductive inks.

Further advantages of the present invention will become apparent from the details that are provided below.

### BRIEF DESCRIPTION OF THE DRAWINGS

FIGS. 1a through 1f are optical microscope images of printed lines at 300× magnification as demonstrated in the use of the invention in the Examples described below.

FIG. 2 is a graphical representation of Width Gain vs. Substrate Polarity using two of the inks as described below in the Examples.

FIG. 3 is a graphical representation of Width Gain vs. Δ(Polarity) for the substrate and ink combinations shown below in TABLE II.

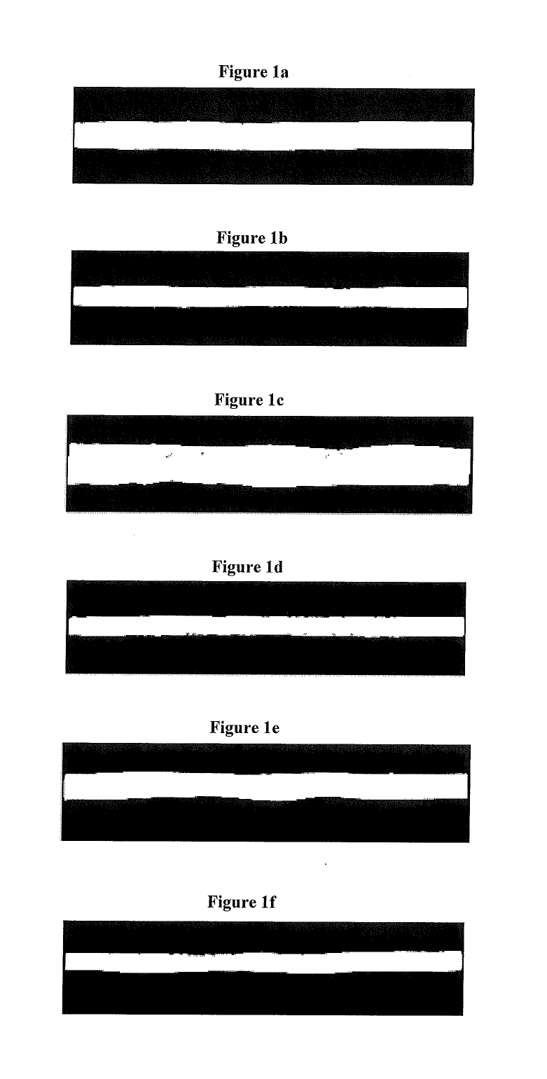

### DETAILED DESCRIPTION OF THE INVENTION

### Definitions

As used herein to define various components of formulations, inks, and layers, unless otherwise indicated, the singular forms “a”, “an”, and “the” are intended to include one or more of the components (that is, including plurality referents).

Each term that is not explicitly defined in the present application is to be understood to have a meaning that is commonly accepted by those skilled in the art. If the construction of a term would render it meaningless or essentially meaningless in its context, the term's definition should be taken from a standard dictionary.

The use of numerical values in the various ranges specified herein, unless otherwise expressly indicated otherwise, are considered to be approximations as though the minimum and maximum values within the stated ranges were both preceded by the word “about”. In this manner, slight variations above and below the stated ranges can be used to achieve substantially the same results as the values within the ranges. In addition, the disclosure of these ranges is intended as a continuous range including every value between the minimum and maximum values.

Surface energy is determined using known techniques such as measuring the contact angle of a sessile drop of liquid on a given surface, pendant drop shape analysis, maximum bubble pressure, or tensiometry. The total surface energy (in mJ/m²) of a substrate surface used in the practice of this invention is represented by γ^{T}. This total surface energy is resolved into polar (γ^{P}) and dispersive (γ^{D}) components of the total surface energy (γ^{T}). Thus, γ^{T}=γ^{P}+γ^{D}. In addition, a polarity value is calculated by the term (γ^{P}/γ^{D})^{1/2} and the polarity value is used in part define the present invention. The term Δ(Polarity) refers to the difference between the polarity values of the substrate/ink pair used to make a printed image. Thus, Δ(Polarity)=(substrate polarity)−(ink polarity). All of the surface energy measurements described herein were made using ASTM Certified “Accu Dyne” test liquids (listed in Table 1 of the ASTM Standard D2578-9 document) as supplied by Diversified Enterprises (Claremont, N.H.).

The difference [Δ(Polarity)] refers to substrate polarity [(γ^{P}/γ^{D})^{1/2}] less the polarity of the ink used to apply a pattern to the substrate surface.

### Method of Printing

Printed patterns are formed on one or more surfaces of a suitable substrate. A variety of substrates can be patterned using this invention including but not limited to, substrate materials comprising polymeric materials such as polyesters, acrylate polymers, polycarbonates, polyamides, polyimides, and polyolefins, cellulosic papers or resin-coated or glass-coated papers, glass or glass-containing composites, ceramics, metals such as aluminum, tin, and copper, and metalized films. Polyethylene terephthalate and polyethylene naphthalate are two useful polyesters that can be used as substrate materials.

The substrates can be surface-treated in some manner to improve adherence of the applied ink for example by reducing the polarity value of the substrate surface compared to the same substrate surface that is untreated. For example, the substrate surface to be patterned can be exposed to corona discharge, mechanical abrasion, flame treatments, or oxygen plasmas, or by coating with various polymeric films, such as poly(vinylidene chloride) or an aromatic polysiloxane as described for example in U.S. Pat. Nos. 5,492,730 (Balaba et al.) and 5,527,562 (Balaba et al.) and U.S. Patent Application Publication 2009/0076217 (Gommans et al.).

Particularly useful substrates are polyesters such as poly(ethylene terephthalate) or poly(vinylidene chloride) films that have been surface-treated as noted above to reduce its polarity value compared to the same polyester surface that is untreated.

In general, the polarity of the substrate surface on which a pattern is to be formed is less than or equal to 0.6, or less than or equal to 0.5, or preferably less than or equal to 0.4.

Any suitable ink can be used in the practice of this invention as long as the polarity of the substrate surface minus the polarity of the ink that is to be applied is less than or equal to 0.1, or typically less than or equal to 0.05. This difference in polarity, Δ(Polarity), is generally greater than or equal to −0.15 or typically greater than −0.10.

With these properties in mind, a worker skilled in the art can choose a suitable ink for a given substrate surface (treated or non-treated). Some ink polarity values are known in the art while others can be determined by routine experimentation using the procedure described above.

Some particularly useful inks include but are not limited to, conductive inks containing conductive particles such as metal flakes or particles. Conductive inks include conductive silver-containing inks, gold-containing inks, copper-containing inks, carbon-containing inks, palladium-containing inks, and inks containing “seed” materials for electroplating or electroless plating. Some of such inks can be obtained commercially from sources such as InkTec (California), Flint Ink Corporation (Michigan), and Methode Development Company (Chicago).

As inks, the dyes, pigments, or other particulate materials are dissolved or suspended in suitable solvents that are known in the art for this purpose. For example, a silver-containing conductive ink can include up to 40 weight % of silver metal particles that are dispersed in aqueous or non-aqueous solvents.

Ink can be applied to the substrate surface using any suitable means including contact printing members such as flexographic printing plates, gravure printing cylinders, intaglio printing members, and letterpress printing plates. Thus, particularly useful contact printing members are those that have relief images that carry the ink. Flexographic printing plates are particularly useful and such flexographic printing plates can be provided from precursors such as those described in U.S. Pat. No. 8,142,987 (Ali et al.) that is incorporated herein by reference.

In many embodiments, the method can be used to provide a printed pattern comprising lines having an average line width of less than 20 μm, or typically fine lines having an average line width of less than 15 μm and generally at least 3 μm. These average values can be determined by measuring the line width in randomly selected locations in images captured from optical micrographs of appropriate magnification.

The printed fine line pattern also generally has a transparency value greater than or equal to 85% and a haze value of less than 3%. In preferred embodiments, the transparency value is greater than or equal to 88% and the haze value is less than 2%. Haze and transparency are determined according to the methods described in ASTM procedure D1003.

Thus, some of the embodiments, the method of this invention provides a printed pattern of fine lines containing a seed material for a subsequent electroless plating process. For example, for copper electroless plating, such seed materials include but are not limited to, metals such as palladium, tin, and silver, or a mixture of tin and palladium.

In other embodiments, the method of this in invention provides a pattern of fine lines having an electrical conductivity that is high enough for a subsequent electroplating process. Such an electrical conductivity is at least 0.1 S/cm and the details of such processes are known in the art.

In still other embodiments, the methods of this invention provides a pattern of fine lines composed of ink that is formulated to protect an underlying uniform metal film during a subsequent etching process. For example, the ink can be formulated to protect an underlying copper film during a subsequent etching process.

The present invention provides at least the following embodiments and combinations thereof, but other combinations of features are considered to be within the present invention as a skilled artisan would appreciate from the teaching of this disclosure:

1. A method for providing a printed pattern, the method comprising:

applying ink to a surface of a substrate to form a pattern on the substrate surface,

wherein the ink and substrate are chosen such that the polarity (γ^{P}/γ^{D})^{1/2} of the substrate surface is less than or equal to 0.6 and the difference in polarity of the substrate surface less the ink polarity [Δ(Polarity)] is less than or equal to 0.1.

2. The method of embodiment 1 comprising applying ink to the surface of the substrate using a contact printing member.

3. The method of embodiment 1 or 2 comprising applying ink to the surface of the substrate using a relief printing member.

4. The method of any of embodiments 1 to 3, wherein the polarity of the substrate surface is less than or equal to 0.5.

5. The method of any of embodiments 1 to 4, wherein the polarity of the substrate surface is less than or equal to 0.4.

6. The method of any of embodiments 1 to 5, wherein the polarity of the surface of the substrate minus the polarity of the ink is less than or equal to 0.1.

7. The method of any of embodiments 1 to 6, wherein the polarity of the surface of the substrate minus the polarity of the ink is less than or equal to 0.05.

8. The method of any of embodiments 1 to 7, wherein the ink is a conductive ink.

9. The method of any of embodiments 1 to 8, wherein the ink is a conductive silver-containing ink.

10. The method of any of embodiments 1 to 9, wherein the substrate has been surface-treated to reduce its polarity value compared to the same substrate surface that is untreated.

11. The method of any of embodiments 1 to 10, wherein the substrate is a polyester that has been surface-treated to reduce its polarity compared to the same polyester surface that is non-treated.

12. The method of any of embodiments 1 to 11, wherein the substrate is a polymeric film that has been surface-treated with poly(vinylidene chloride) or an aromatic polysiloxane.

13. The method of any of embodiments 1 to 12 for providing a printed pattern comprising lines having an average line width of less than 20 μm.

14. The method of any of embodiments 1 to 13 for providing a fine line pattern having a transparency value greater than or equal to 85% and a haze value of less than 3%.

15. The method of any of embodiments 1 to 14 for providing a pattern of fine lines containing a seed material for a subsequent electroless plating process.

16. The method of any of embodiments 1 to 14 for providing a pattern of fine lines having an electrical conductivity that is high enough for a subsequent electroplating process.

17. The method of any of embodiments 1 to 14 for providing a pattern of fine lines of ink that is formulated to protect an underlying uniform metal film during a subsequent etching process.

The following Examples are provided to illustrate the practice of this invention and are not meant to be limiting in any manner.

Flexographic printing plates were prepared for use as the contact printing member for applying a pattern of ink to the various substrates in the following Examples. Each flexographic printing plate was prepared from a commercially available Flexcel® NX precursor and imaging process as described for example in Example 1 of U.S. Pat. No. 8,142,987 (noted above).

The substrates and inks used to provide printed relief images with line patterns are shown below in TABLE I. Flexographic printing of ink was performed onto each substrate on a desktop flexographic proofer/printer (FlexiProofer Model 100). One example ink used was a solvent-based, nanoparticle silver-containing ink (“InkTec”) that was obtained from InkTec America Corp. (Santa Ana, Calif.), and another ink was an aqueous black ink (“Black Aqueous”) that was obtained from Flint Ink Corp. (Ann Arbor, Mich.). The surface energy data for the inks and substrates are shown below in TABLE I. Note that some of the substrates have been treated using the identified materials.

TABLE I

| Material | γ^{D} | γ^{P} | γ^{T} | Polarity |
|---|---|---|---|---|
| Substrate | | | | |
| Untreated PET | 26 | 8 | 34 | 0.555 |
| Untreated PVDC | 35 | 10 | 45 | 0.535 |
| PET/Aquaphobe ™ CM | 30 | 4 | 34 | 0.365 |
| PVDC/Aquaphobe ™ CM | 32 | 3 | 35 | 0.306 |
| PET/AP | 28 | 10 | 38 | 0.598 |
| PET/AP/Aquaphobe ™ CM | 30 | 4 | 34 | 0.365 |
| Ink | | | | |
| InkTec | 32 | 4 | 36 | 0.354 |
| Black Aqueous | 30 | 6 | 36 | 0.447 |

PET refers to polyethylene terephthalate.
PVDC refers to poly(vinylidene chloride).
Aquaphobe ™ CM is a polydimethylsiloxane that is available from Gelest Corporation, used to treat the various polymeric films.
“AP” refers to commercially available PET films that are pre-coated with adhesion promoters that can be obtained from manufacturers such as with DuPont and Mitsubishi.

TABLE II below summarizes the printed image results obtained from relief images in flexographic printing plates having 9.5 μm wide lines using various combinations of substrates and inks shown in TABLE I.

TABLE II

| | | | | | | Plate Line | Printed Line | Width | Width |
|---|---|---|---|---|---|---|---|---|---|
| | | | Polarity | Polarity | | Width | Width | Gain | Gain |
| Example | Substrate | Ink | (Substrate) | (Ink) | Δ(Polarity) | (μm) | (μm) | (μm) | (%) |
| A | Untreated PET | InkTec | 0.555 | 0.354 | 0.201 | 9.5 | 22 | 12.5 | 132 |
| B | PET/Aquaphobe ™ CM | InkTec | 0.371 | 0.354 | 0.017 | 9.5 | 17 | 7.5 | 79 |
| C | PET/AP | InkTec | 0.598 | 0.354 | 0.244 | 9.5 | 25.5 | 16 | 168 |
| D | PET/AP/Aquaphobe ™ | InkTec | 0.365 | 0.354 | 0.011 | 9.5 | 17 | 7.5 | 79 |
| | CM | | | | | | | | |
| E | Untreated PVDC | InkTec | 0.535 | 0.354 | 0.181 | 9.5 | 20.5 | 11 | 116 |
| F | PVDC/Aquaphobe ™ CM | InkTec | 0.306 | 0.354 | −0.048 | 9.5 | 17 | 7.5 | 79 |
| G | Untreated PET | Black | 0.555 | 0.447 | 0.108 | 9.5 | 18.5 | 9 | 95 |
| | | aqueous | | | | | | | |
| H | PET/Aquaphobe ™ CM | Black | 0.371 | 0.447 | −0.076 | 9.5 | 16.5 | 7 | 74 |
| | | aqueous | | | | | | | |
| I | Untreated PVDC | Black | 0.535 | 0.447 | 0.088 | 9.5 | 19 | 9.5 | 100 |
| | | aqueous | | | | | | | |
| J | PVDC/Aquaphobe ™ CM | Black | 0.306 | 0.447 | −0.141 | 9.5 | 16 | 6.5 | 68 |
| | | aqueous | | | | | | | |
| K | PET/AP | Black | 0.598 | 0.447 | 0.151 | 9.5 | 17 | 7.5 | 79 |
| | | aqueous | | | | | | | |
| L | PET/AP/Aquaphobe ™ | Black | 0.365 | 0.447 | −0.082 | 9.5 | 16.5 | 7 | 74 |
| | CM | aqueous | | | | | | | |

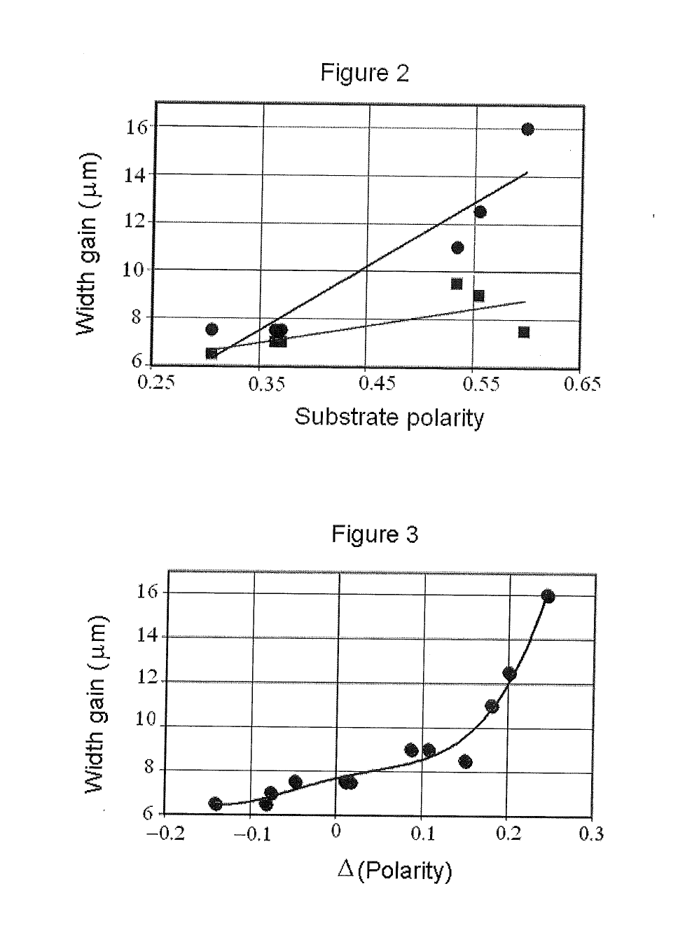

The line “width gain” data shown in TABLE II was plotted against polarity as shown in FIG. 2 where the circular data points correspond to the InkTec ink data and the square data points correspond to the black aqueous ink data. The line “width gain” data acquired using the silver-containing ink demonstrated very good correlation to substrate polarity. The same data acquired using the aqueous black ink showed fair correlation to substrate polarity. However, it is clear that the two inks showed different relationships between line width and substrate polarity, indicating that the conductive silver-containing ink performed better than the aqueous black ink. However, the aqueous black ink may be used with better results on different substrates.

The line “width gain” data was also plotted against Δ(Polarity) as shown in FIG. 3. These plots indicate very good correlation of the line “width gain” data to the Δ(Polarity) for both of the inks used in the examples shown in TABLE II. These data indicate that the lowest line width gain values in the printed patterns were obtained when the difference in polarity between substrate and ink was less than 0.1 (and this difference can also have a negative value).

The invention has been described in detail with particular reference to certain preferred embodiments thereof, but it will be understood that variations and modifications can be effected within the spirit and scope of the invention.

1. A method for providing a printed pattern, the method comprising:
applying ink to a surface of a substrate to form a pattern on the substrate surface,
wherein the ink and substrate are chosen such that the polarity (γ^{P}/γ^{D})^{1/2} of the substrate surface is less than or equal to 0.6 and the difference in polarity of the substrate surface less the ink polarity [Δ(Polarity)] is less than or equal to 0.1.

2. The method of claim 1 comprising applying ink to the surface of the substrate using a contact printing member.

3. The method of claim 1 comprising applying ink to the surface of the substrate using a relief printing member.

4. The method of claim 1, wherein the polarity of the substrate surface is less than or equal to 0.5.

5. The method of claim 1, wherein the polarity of the substrate surface is less than or equal to 0.4.

6. The method of claim 1, wherein the polarity of the surface of the substrate minus the polarity of the ink is less than or equal to 0.1.

7. The method of claim 1, wherein the polarity of the surface of the substrate minus the polarity of the ink is less than or equal to 0.05.

8. The method of claim 1, wherein the ink is a conductive ink.

9. The method of claim 1, wherein the ink is a conductive silver-containing ink.

10. The method of claim 1, wherein the substrate has been surface-treated to reduce its polarity value compared to the same substrate surface that is untreated.

11. The method of claim 1, wherein the substrate is a polyester that has been surface-treated to reduce its polarity compared to the same polyester surface that is non-treated.

12. The method of claim 1, wherein the substrate is a polymeric film that has been surface-treated with poly(vinylidene chloride) or an aromatic polysiloxane.

13. The method of claim 1 for providing a printed pattern comprising lines having an average line width of less than 20 μm.

14. The method of claim 1 for providing a fine line pattern having a transparency value greater than or equal to 85% and a haze value of less than 3%.

15. The method of claim 1 for providing a pattern of fine lines containing a seed material for a subsequent electroless plating process.

16. The method of claim 1 for providing a pattern of fine lines having an electrical conductivity that is high enough for a subsequent electroplating process.

17. The method of claim 1 for providing a pattern of fine lines of ink that is formulated to protect an underlying uniform metal film during a subsequent etching process.
